(19) United States
(12) Patent Application Publication
(10) Pub. No.: US 2021/0209466 A1
(43) Pub. Date: Jul. 8, 2021

(54) INFORMATION PROCESSING APPARATUS, INFORMATION PROCESSING METHOD, AND PROGRAM

(71) Applicant: SONY CORPORATION, TOKYO (JP)

(72) Inventor: HIDEHO GOMI, TOKYO (JP)

(21) Appl. No.: 17/057,846

(22) PCT Filed: Apr. 22, 2019
(86) PCT No.: PCT/JP2019/016974

§ 371 Date: Nov. 23, 2020

(30) Foreign Application Priority Data
May 31, 2018 (JP) 2018-105060

(51) Int. Cl. G06N 3/08

(52) U.S. Cl. CPC G06N 3/08; G06N 3/04

(57) ABSTRACT

An information processing apparatus includes: a recognition unit that performs recognition processing by using a neural network; and a controller that switches a weight coefficient set of the neural network with a learned weight coefficient set selected from a plurality of learned weight coefficient sets. The controller is further capable of merging the plurality of learned weight coefficient sets into a learned weight coefficient set and setting the learned weight coefficient set in the neural network.

### TECHNICAL FIELD

The present technology relates to an information processing apparatus, an information processing method, and a program for performing recognition processing using a neural network.

### BACKGROUND ART

In recent years, a technique of performing recognition such as discrimination and classification using a recognizer created by machine learning of a large amount of data has been put into practical use.

For example, in the image recognition technology, there is a technique of storing a parameter that is set in a machine learning classifier for each person, extracting a feature amount from a person face image that is input as a recognition target, inputting the extracted feature amount to the machine learning classifier for each person, and classifying a person as a recognition target (see Patent Literature 1).

### CITATION LIST

### Patent Literature

Patent Literature 1: Japanese Patent Application Laid-open No. 2015-69580

### DISCLOSURE OF INVENTION

### Technical Problem

The recognizer generates weight coefficients between units in the neural network on the basis of provided learning data and determines, on the basis of the weight coefficients between units, what recognition result is to be output with respect to the input data from the recognizer. Thus, when a target condition of the recognizer, that is, a condition as to what kind of tendency of a recognition result is to be obtained with respect to the input data, is intended to be changed, even if the content of the change is a partial change, it takes time and labor to perform such a change, which needs an operation of redoing the machine learning and resetting the weight coefficients between the respective units.

It is an object of the present technology to provide an information processing apparatus, an information processing method, and a program that are capable of easily changing recognition processing of a recognizer.

### Solution to Problem

In order to solve the above-mentioned problems, an information processing apparatus according to an embodiment of the present technology includes: a recognition unit that performs recognition processing by using a neural network; and a controller that switches a weight coefficient set of the neural network with a learned weight coefficient set selected from a plurality of learned weight coefficient sets.

Note that the “learned weight coefficient set” means a weight coefficient between units obtained when learning is performed by a model of a certain neural network.

The information processing apparatus may further include a storage unit that stores the plurality of learned weight coefficient sets.

Each of the plurality of learned weight coefficient sets may be prepared for each target condition for the recognition processing of the recognition unit.

The controller may merge a plurality of learned weight coefficient sets, which is included in the plurality of learned weight coefficient sets stored in the storage unit, into a learned weight coefficient set, and set the learned weight coefficient set in the neural network.

The controller may obtain a mean of weight coefficients between identical units in each of the plurality of learned weight coefficient sets, to thereby merge the plurality of learned weight coefficient sets into a learned weight coefficient set.

The controller may obtain a mean and a maximum value of weight coefficients between identical units in each of the plurality of learned weight coefficient sets and multiplies the mean value with the maximum value, to thereby merge the plurality of learned weight coefficient sets into a learned weight coefficient set.

The controller may select one or more learned weight coefficient sets from the plurality of learned weight coefficient sets on the basis of a selection command from a user.

An information processing method according to an embodiment of the present technology includes switching, by a controller, a weight coefficient set of a neural network with a learned weight coefficient set selected from a plurality of learned weight coefficient sets, recognition processing being performed for the weight coefficient set of the neural network.

### Advantageous Effects of Invention

As described above, according to the present technology, it is possible to easily change the recognition processing of the recognizer.

### BRIEF DESCRIPTION OF DRAWINGS

FIG. 1 is a block diagram showing a configuration of an information processing apparatus according to a first embodiment of the present technology.

FIG. 2 is a diagram showing a configuration of a target condition database 23 in the information processing apparatus 100 of FIG. 1.

FIG. 3 is a diagram showing an example of the target condition database 23 used in an application to recommend a restaurant.

FIG. 4 is a diagram showing an example of the target condition database 23 used in an application to recommend an optimal route.

FIG. 5 is a diagram showing an operation of switching processing of a learned weight coefficient set.

FIG. 6 is a diagram showing an operation of merging processing of N learned weight coefficient sets.

FIG. 7 is a diagram for describing a merging method 1 for N learned weight coefficient sets.

FIG. 8 is a diagram for describing acquisition of a learned weight coefficient set from a cloud.

FIG. 9 is a diagram showing a procedure of mutual exchange when the information processing apparatus 100 acquires a learned weight coefficient set from the cloud 2.

FIG. 10 is a diagram for describing a merging method 2 for N learned weight coefficient sets.

### MODE(S) FOR CARRYING OUT THE INVENTION

An embodiment according to the present technology will be described below.

### First Embodiment

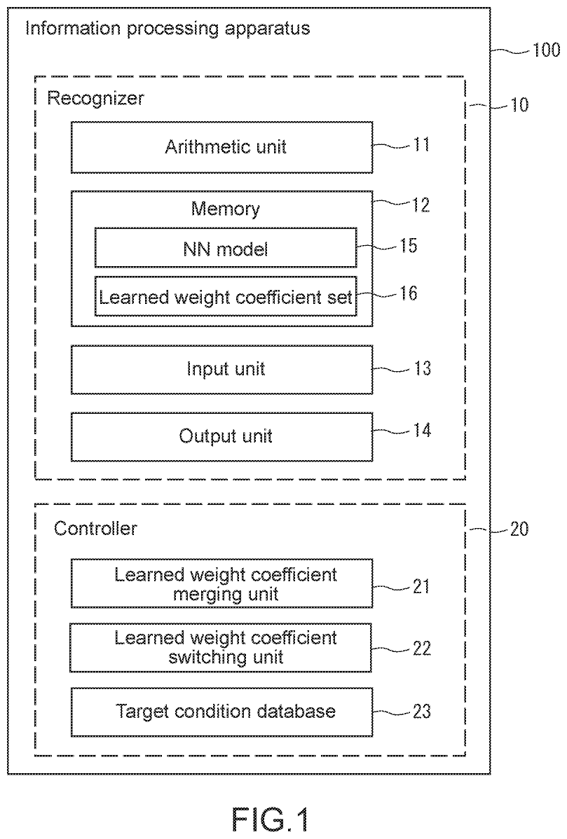

FIG. 1 is a block diagram showing a configuration of an information processing apparatus according to a first embodiment of the present technology.

As shown in FIG. 1, an information processing apparatus 100 includes a recognizer 10 and a controller 20.

The recognizer 10 and the controller 20 are constituted by, for example, a central processing unit (CPU), a main memory such as a random access memory (RAM), a storage device such as a hard disk drive (HDD), and a computer including user interfaces such as a keyboard, a mouse, a display, a speaker, and a microphone. Each of the recognizer 10 and the controller 20 may be constituted by a separate computer organically coupled to each other via a data transmission path such as a network.

(Configuration of Recognizer 10)

The recognizer 10 includes an arithmetic unit 11, a memory 12, an input unit 13, and an output unit 14.

The arithmetic unit 11 performs arithmetic processing for recognition processing using a neural network (hereinafter referred to as “NN”) by using the memory 12. The memory 12 stores an NN model 15 and a learned weight coefficient set 16 corresponding to a target condition.

Here, the “NN model” described above is information regarding components such as the number of layers of the neural network and the number of nodes for each layer. The “weight coefficient” described above is a value indicating the coupling strength between units between the layers in the neural network. The “weight coefficient set” is a group of the coupling strengths (weight coefficients) between all units in the neural network. The “learned weight coefficient set” described above is a weight coefficient set obtained by learning. In this embodiment, the learned weight coefficient set is prepared for each target condition of the recognizer. The “target condition” means a condition to be given to the recognition processing performed by the recognizer 10.

The input unit 13 inputs data introduced into the recognizer 10 (an input layer of the neural network).

The output unit 14 outputs a recognition result, which is derived from the recognizer 10 (an output layer of the neural network), to a user.

(Logical Configuration of Controller 20)

The controller 20 includes a learned weight coefficient merging unit 21, a learned weight coefficient switching unit 22, and a target condition database 23.

The controller 20 controls the operation of each unit of the controller 20.

The target condition database 23 is a database for storing a plurality of learned weight coefficient sets corresponding to respective target conditions.

The learned weight coefficient switching unit 22 switches the learned weight coefficient set to be set in the memory 12 of the recognizer 10. The switching of the learned weight coefficient set is executed by using, as a trigger, a case in which a user specifies the switching or a case in which the information processing apparatus 100 detects a predetermined state.

The learned weight coefficient merging unit 21 merges a plurality of learned weight coefficient sets stored in the target condition database 23 to generate a new learned weight coefficient set.

(Configuration of Target Condition Database 23)

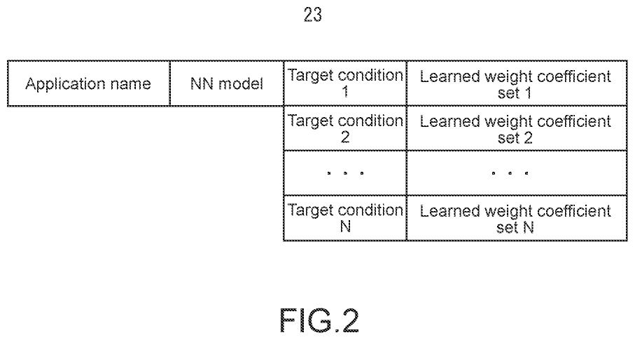

FIG. 2 is a diagram showing a configuration of the target condition database 23.

FIG. 2 shows a configuration example of the target condition database 23 managed for each application. To support a plurality of applications, such a target condition database 23 is provided for each application.

The target condition database 23 is constituted by an application name, an NN model name, a target condition, and a learned weight coefficient set.

The application name is the name of recognition processing performed by the recognizer 10.

The NN model is information regarding an NN model used in the recognizer 10.

The target condition is a condition to be given to the recognition processing performed by the recognizer 10. A plurality of target conditions may exist for one application.

The learned weight coefficient set is stored for each target condition.

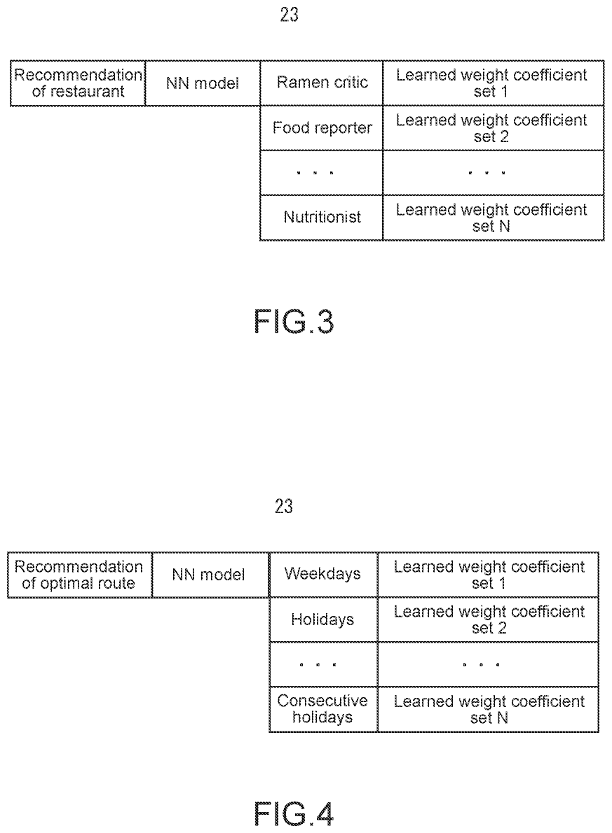

FIG. 3 is an example of the target condition database 23 in a case of assuming an application that outputs a recommended restaurant in response to inputs such as time, location, and price. In this example, for example, adviser job types such as a “ramen critic”, a “food reporter”, and a “nutritionist” are the target conditions. In this case, a recognizer 10, which outputs a different recommended restaurant due to differences in the expertise, preferences, and the like of the respective adviser job types even if the identical time, place, and price are given as inputs, is obtained as an application.

Further, as shown in FIG. 4, in a case of assuming an application that outputs route information to a destination in response to inputs of a destination, whether or not a toll road is used, a desired arrival time, and the like, since an optimal route changes depending on weekdays, holidays, and consecutive holidays, for example, each of “weekdays”, “holidays”, and “consecutive holidays” can be set as an target condition.

As described above, in the target condition database 23, a plurality of target conditions is associated with one application and one NN model, and a learned weight coefficient set is associated with each target condition in a one-to-one manner. Note that the identical learned weight coefficient set may be associated with a plurality of different target conditions.

(Switching Processing of Learned Weight Coefficient Set)

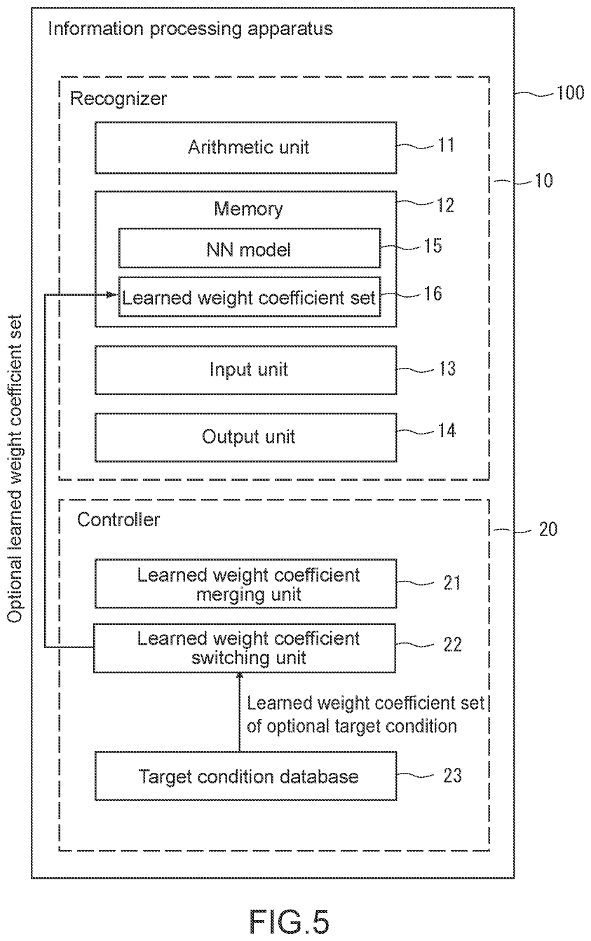

FIG. 5 is a diagram showing an operation of the switching processing of the learned weight coefficient set.

When a user of the information processing apparatus 100 specifies switching or when the information processing apparatus 100 detects a predetermined state, the controller 20 requests the learned weight coefficient switching unit 22 to switch the learned weight coefficient set. The request includes information for specifying a learned weight coefficient set of a target condition as a switching destination. In response to the request, the learned weight coefficient switching unit 22 reads the learned weight coefficient set of the specified target condition from the target condition database 23, and overwrites a learned weight coefficient storage area of the memory 12 of the recognizer 10.

When the learned weight coefficient set on the memory 12 is simply rewritten in such a manner, the contents of the recognition processing of the recognizer 10 can be uniquely switched without taking the step of machine learning.

For example, assuming the application that outputs a recommended restaurant shown in FIG. 3, when the user selects the “ramen critic” as a target condition, the learned weight coefficient switching unit 22 reads a learned weight coefficient set associated with the target condition of the “ramen critic” from the target condition database 23, and overwrites the learned weight coefficient storage area of the memory 12 of the recognizer 10. As a result, the recognizer 10 is set as a recognizer 10 that performs recognition processing of determining a recommended restaurant from the viewpoint of a ramen critic by inputting time, location, price, and the like.

Similarly, when the user selects the “food reporter” as a target condition, the learned weight coefficient set associated with the target condition of the “food reporter” is overwritten in the learned weight coefficient storage area of the memory 12 of the recognizer 10, and a recognizer 10 that performs recognition processing of determining a recommended restaurant from the viewpoint of a food reporter, that is, from the simplicity considering the recent trend, or the like, is set. Similarly, when the user selects the “nutritionist” as a target condition, the learned weight coefficient set associated with the target condition of the “nutritionist” is overwritten in the learned weight coefficient storage area of the memory 12 of the recognizer 10, and a recognizer 10 that performs recognition processing of determining a recommended restaurant from the viewpoint of a nutritionist, that is, from the viewpoint of emphasizing nutrition is set. Thus, the user can select an optional target condition according to a mood or necessity at that time and receive a notification of a recommended restaurant matched with the target condition from the output unit 14.

(Merging of N Learned Weight Coefficient Sets)

Next, description will be given on an operation, in the information processing apparatus 100 of this embodiment, of merging learned weight coefficient sets of N target conditions selected from those stored in the target condition database 23 to generate a new learned weight coefficient set.

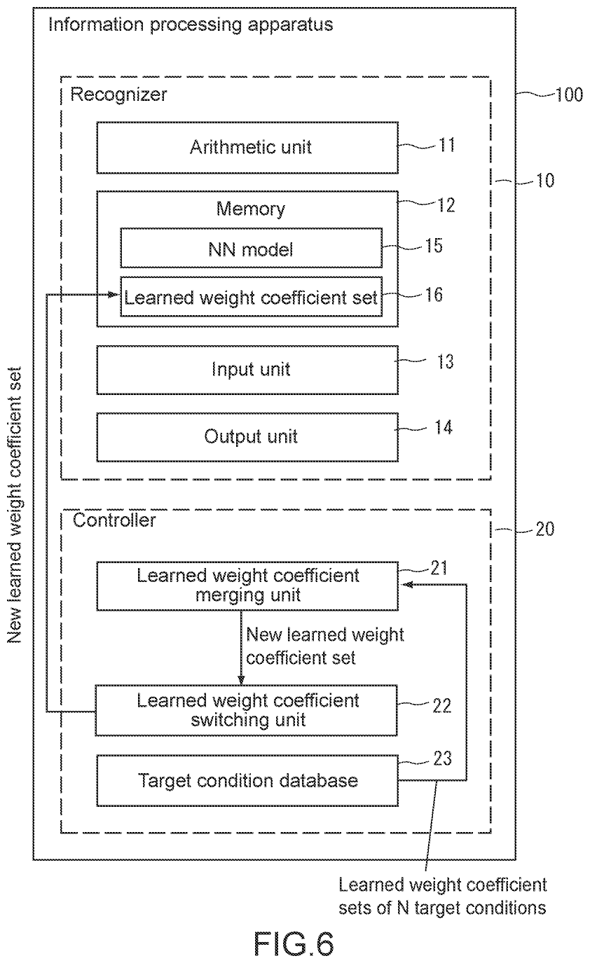

FIG. 6 is a diagram showing an operation of processing of merging N learned weight coefficient sets.

First, the learned weight coefficient merging unit 21 reads learned weight coefficient sets of N respective target conditions from the target condition database 23. The N learned weight coefficient sets to be merged may be optionally selected by the user, for example. In the selection of learned weight coefficient sets to be merged, all of the target conditions of the respective learned weight coefficient sets stored in the target condition database 23 are presented, and thus the user may select an optional target condition while referring to the contents of the presented target conditions.

Next, the learned weight coefficient merging unit 21 merges the learned weight coefficient sets of the N respective target conditions read from the target condition database 23 to generate a new learned weight coefficient set. Next, a merging method will be described.

(Merging Method 1)

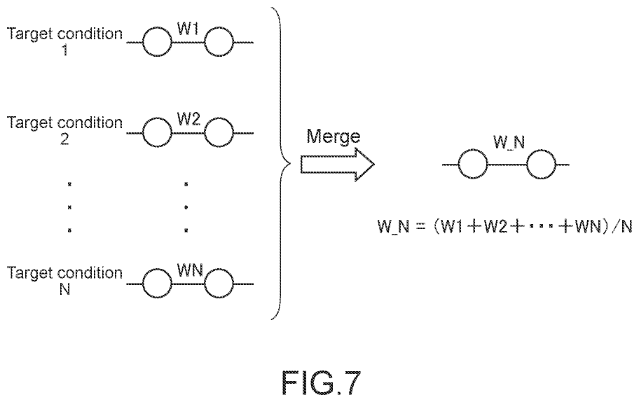

FIG. 7 is a diagram for describing a merging method 1 for N learned weight coefficient sets.

W1 represents a weight coefficient that is the coupling strength between units of each layer in a learned weight coefficient set of a target condition 1, W2 represents a weight coefficient that is the coupling strength between units of each layer in a learned weight coefficient set of a target condition 2, and WN represents a weight coefficient that is the coupling strength between units of each layer in a learned weight coefficient set of a target condition N. Note that, actually, weight coefficients are given between all the units of each layer in each set, but only the weight coefficients W1, W2, . . . , WN between units at one location will be described here for the sake of simplicity.

Assuming that W_N is a merging result of the learned weight coefficients, W_N is calculated by the following equation (1), for example.

W_N=(W1+W2+ . . . +WN)/N (1)

That is, a mean value of the weight coefficients W1, W2, . . . , WN of the respective target conditions 1, 2, . . . , N can be obtained as a new learned weight coefficient W_N.

When a set of the new learned weight coefficients W_N is obtained by the learned weight coefficient merging unit 21, the controller 20 requests the learned weight coefficient switching unit 22 to set the set of the new learned weight coefficients W_N in the recognizer 10. In response to this request, the learned weight coefficient switching unit 22 overwrites the set of the new learned weight coefficients W_N in the learned weight coefficient storage area of the memory 12 of the recognizer 10.

For example, if the user selects two target conditions of the “ramen critic” and the “nutritionist” in the target condition database 23 for the application that outputs a recommended cafeteria shown in FIG. 3, the learned weight coefficient merging unit 21 generates a new learned weight coefficient set that is obtained by merging the learned weight coefficient sets of the two respective target conditions. The learned weight coefficient switching unit 22 sets the new learned weight coefficient set in the recognizer 10. Thus, an appropriate cafeteria/restaurant is determined from the two viewpoints of the ramen critic and the nutritionist in response to the inputs such as time, location, and price from the user, and a result is presented to the user through the output unit 14.

(Acquisition of Learned Weight Coefficient Set from Cloud)

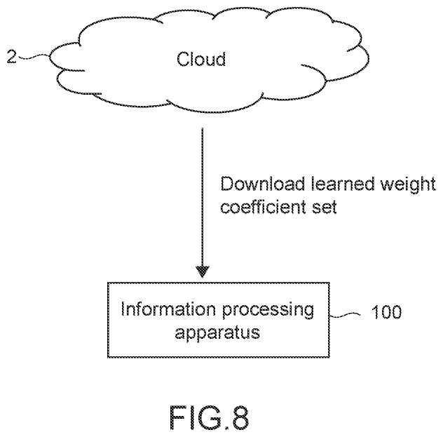

In the above embodiment, the case where the information processing apparatus 100 includes the local target condition database 23 has been described, but as shown in FIG. 8, the learned weight coefficient set for each target condition may be managed by a server of a cloud 2. The information processing apparatus 100 requests the cloud 2 to download a learned weight coefficient set to acquire an optional learned weight coefficient set, and the learned weight coefficient switching unit 22 sets the learned weight coefficient set in the recognizer 10.

Further, the information processing apparatus 100 is capable of requesting the cloud 2 to download learned weight coefficient sets respectively corresponding to the N target conditions in accordance with an instruction from the user. In the information processing apparatus 100, the learned weight coefficient merging unit 21 merges the learned weight coefficient sets of the N target conditions acquired from the cloud 2 to generate a new learned weight coefficient set, and the learned weight coefficient switching unit 22 sets the generated learned weight coefficient set in the recognizer 10.

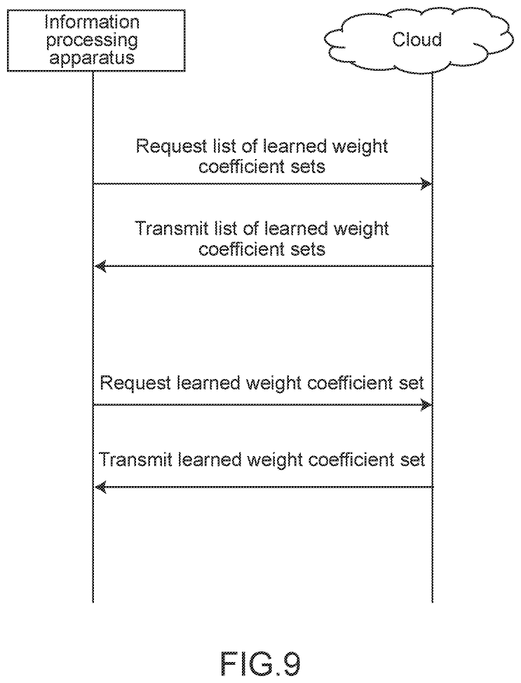

FIG. 9 is a diagram showing a procedure of mutual exchange when the information processing apparatus 100 acquires a learned weight coefficient set from the cloud 2.

The information processing apparatus 100 first requests a list of learned weight coefficient sets from the cloud 2 in order to confirm what target conditions the cloud 2 has. The information processing apparatus 100 presents the list acquired from the cloud 2 to the user through the output unit 14 or the like. This list discloses information such as to what application each learned weight coefficient set is applied, what NN model is used for each learned weight coefficient set, and what target conditions each learned weight coefficient set has. The user of the information processing apparatus 100 selects one or more learned weight coefficient sets from the presented list. The information processing apparatus 100 requests the cloud 2 to download the one or more learned weight coefficient sets selected by the user. In response to the request, the cloud 2 transmits the one or more learned weight coefficient sets to the information processing apparatus 100.

(Merging Method 2)

Next, another method of merging N learned weight coefficient sets will be described.

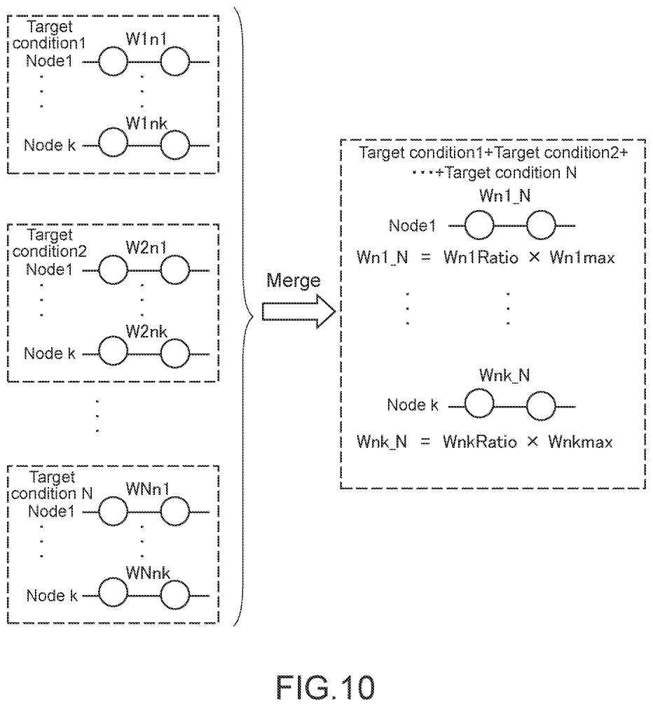

FIG. 10 is a diagram for describing a merging method 2 of N learned weight coefficient sets.

The merging method 2 is to obtain each of a mean and a maximum value of the weight coefficients between the identical units in the N learned weight coefficient sets and multiply the mean value by the maximum value to merge them into a learned weight coefficient set.

W1n1, . . . , Wink are weight coefficients of respective nodes 1, . . . , k in the identical hierarchy in the learned weight coefficient set of the target condition 1.

W2n1, . . . , W2nk are weight coefficients of respective nodes 1, . . . , k in the identical hierarchy in the learned weight coefficient set of the target condition 2.

WNn1, . . . , WNnk are weight coefficients of respective nodes 1, . . . , k in the identical hierarchy in the learned weight coefficient set of the target condition N.

Wn1_NNnk_N are each a merging result of the learned weight coefficient sets of the N target conditions 1, . . . , N, and each indicates a weight coefficient of the identical hierarchy in the NN model 15. Here, Wn1_NNnk_N are respectively given by the following equations.

Wn1_N=Wn1Ratio×Wn1 max (2)

Wnk_N=WnkRatio×Wnkmax (3)

Wn1Ratio is given by the following equation.

Wn1Ratio=(W1n1Ratio+W2n1Ratio+ . . . +WNn1Ratio)/N (4)

WnkRatio is given by the following equation.

WnkRatio=(W1nkRatio+W2nkRatio+ . . . +WNnkRatio)/N (5)

W1n1Ratio in the equation (4) above is given by the following equation, assuming W1n1+ . . . +W1nk as W1nSum.

W1n1Ratio=W1n1/W1nSum (6)

Similarly, W1nkRatio in the equation (5) above is given by the following equation.

W1nkRatio=W1nk/W1nSum (7)

Wn1max represents a maximum value of the weight coefficient of the synaptic connection of the node 1 in the learned weight coefficient sets of the respective target conditions 1, . . . , #N, and Wnkmax represents a maximum value of the weight coefficient of the node k in the learned weight coefficient sets of the respective target conditions 1, . . . , #N.

Thus, it is possible to obtain a merging result of the learned weight coefficients, taking into account the degree of influence of the nodes 1, . . . , k of the identical hierarchy.

(Adjustment of Learned Weight Coefficient)

In a case where the learned weight coefficient sets of a plurality of target conditions are merged to generate a new learned weight coefficient set, the degree of influence on the new learned weight coefficient set may be adjusted for each target condition.

For example, there is a method of multiplying a learned weight coefficient set for each target condition by an adjustment value and then performing merging by the above method. That is, N adjustment values given to the learned weight coefficient sets of the N target conditions are assumed to be α1, α2, . . . , αN (where α1+α2+ . . . +αN=1), and a larger adjustment value only needs to be assigned to the learned weight coefficient set of the target condition to be reflected more strongly in the recognition processing. Thus, for example, if the learned weight coefficient sets of the target conditions 1, 2, and 3 are merged with the adjustment value for the target condition 1 being 0.5, the adjustment value for the target condition 2 being 0.2, and the adjustment value for the target condition 3 being 0.3, a new learned weight coefficient set is obtained by merging the learned weight coefficient sets of the target conditions 1, 2, and 3 with the ratio of 5:2:3. Thus, a new learned weight coefficient set merged with a free ratio can be obtained.

A calculation formula in the case of adjusting the first merging method is shown below.

W_N=(α1×W1+α2×W2+ . . . +αn×WN)/n

A calculation formula in the case of adjusting the second merging method is shown below.

$$Wn 1 \_ N = Wn 1 Ratio \times Wn 1 max \\ [ Wn 1 Ratio = ( α1 \times Wn 1 Ratio + α2 \times Wn 2 Ratio + … + α n \times WNn Ratio ) / n ]$$

$$…$$

$$Wnk \_ N = Wnk Ratio \times Wnk max \\ [ Wnk Ratio = ( α1 \times Wnk Ratio + α2 \times Wnk Ratio + … + α n \times Wnk Ratio ) / n ]$$

### Effect Etc. Of this Embodiment

As described above, according to this embodiment, it is possible to change the recognition processing of the recognizer 10 only by rewriting the learned weight coefficient set on the memory 12. That is, it is possible to change the recognition processing of the recognizer 10 without taking the step of machine learning, and to increase the speed. Further, since machine learning is not performed in the recognizer 10, a huge memory area necessary for machine learning becomes unnecessary, and cost reduction can be achieved. In addition, since the recognition processing of the recognizer 10 can be changed only by switching the learned weight coefficient set, restarting of the application becomes unnecessary, and the processing can be performed continuously.

Further, according to this embodiment, since the recognition processing of the recognizer 10 can be executed with a new learned weight coefficient set obtained by merging the N learned weight coefficient sets, the recognition processing of the recognizer 10 can be changed without changing the learned weight coefficient set by the re-learning. As a result, it is possible to achieve an information processing apparatus less expensive than an information processing apparatus including no learning device (including only the recognizer 10).

In addition, a new learned weight coefficient set is acquired from the cloud 2, and thus various types of recognition processing can be executed by the recognizer 10 in the information processing apparatus 100.

It is needless to say that the learned weight coefficient set is obtained from the outside not only via the network but also via a medium such as a semiconductor memory or a disk.

Note that the present technology can take the following configurations.

(1) An information processing apparatus, including:

a recognition unit that performs recognition processing by using a neural network; and

a controller that switches a weight coefficient set of the neural network with a learned weight coefficient set selected from a plurality of learned weight coefficient sets.

(2) The information processing apparatus according to (1), further including

a storage unit that stores the plurality of learned weight coefficient sets.

(3) The information processing apparatus according to (2), in which

each of the plurality of learned weight coefficient sets is prepared for each target condition for the recognition processing of the recognition unit.

(4) The information processing apparatus according to (2) or (3), in which

the controller merges a plurality of learned weight coefficient sets, which is included in the plurality of learned weight coefficient sets stored in the storage unit, into a learned weight coefficient set, and sets the learned weight coefficient set in the neural network.

(5) The information processing apparatus according to (4), in which

the controller obtains a mean of weight coefficients between identical units in each of the plurality of learned weight coefficient sets, to thereby merge the plurality of learned weight coefficient sets into a learned weight coefficient set.

(6) The information processing apparatus according to (4), in which

the controller obtains a mean and a maximum value of weight coefficients between identical units in each of the plurality of learned weight coefficient sets and multiplies the mean value with the maximum value, to thereby merge the plurality of learned weight coefficient sets into a learned weight coefficient set.

(7) The information processing apparatus according to any one of (1) to (6), in which

the controller selects one or more learned weight coefficient sets from the plurality of learned weight coefficient sets on the basis of a selection command from a user.

(8) An information processing method, including

switching, by a controller, a weight coefficient set of a neural network with a learned weight coefficient set selected from a plurality of learned weight coefficient sets, recognition processing being performed for the weight coefficient set of the neural network.

(9) The information processing method according to (8), further including

storing the plurality of learned weight coefficient sets in a storage unit.

(10) The information processing method according to (9), in which

each of the plurality of learned weight coefficient sets is prepared for each target condition for the recognition processing of the recognition unit.

(11) The information processing method according to (9) or (10), in which

the controller merges a plurality of learned weight coefficient sets, which is included in the plurality of learned weight coefficient sets stored in the storage unit, into a learned weight coefficient set, and sets the learned weight coefficient set in the neural network.

(12) The information processing method according to (11), in which

the controller obtains a mean of weight coefficients between identical units in each of the plurality of learned weight coefficient sets, to thereby merge the plurality of learned weight coefficient sets into a learned weight coefficient set.

(13) The information processing method according to (11), in which

the controller obtains a mean and a maximum value of weight coefficients between identical units in each of the plurality of learned weight coefficient sets and multiplies the mean value with the maximum value, to thereby merge the plurality of learned weight coefficient sets into a learned weight coefficient set.

(14) The information processing method according to any one of (8) to (13), in which

the controller selects one or more learned weight coefficient sets from the plurality of learned weight coefficient sets on the basis of a selection command from a user.

### REFERENCE SIGNS LIST

10 recognizer
11 arithmetic unit
12 memory
13 input unit
14 output unit
15 NN model
16 learned weight coefficient set
200 controller
21 learned weight coefficient merging unit
22 learned weight coefficient switching unit
23 target condition database
100 information processing apparatus

1. An information processing apparatus, comprising:
a recognition unit that performs recognition processing by using a neural network; and
a controller that switches a weight coefficient set of the neural network with a learned weight coefficient set selected from a plurality of learned weight coefficient sets.

2. The information processing apparatus according to claim 1, further comprising
a storage unit that stores the plurality of learned weight coefficient sets.

3. The information processing apparatus according to claim 2, wherein
each of the plurality of learned weight coefficient sets is prepared for each target condition for the recognition processing of the recognition unit.

4. The information processing apparatus according to claim 3, wherein
the controller merges a plurality of learned weight coefficient sets, which is included in the plurality of learned weight coefficient sets stored in the storage unit, into a learned weight coefficient set, and sets the learned weight coefficient set in the neural network.

5. The information processing apparatus according to claim 4, wherein
the controller obtains a mean of weight coefficients between identical units in each of the plurality of learned weight coefficient sets, to thereby merge the plurality of learned weight coefficient sets into a learned weight coefficient set.

6. The information processing apparatus according to claim 4, wherein
the controller obtains a mean and a maximum value of weight coefficients between identical units in each of the plurality of learned weight coefficient sets and multiplies the mean value with the maximum value, to thereby merge the plurality of learned weight coefficient sets into a learned weight coefficient set.

7. The information processing apparatus according to claim 4, wherein
the controller selects one or more learned weight coefficient sets from the plurality of learned weight coefficient sets on a basis of a selection command from a user.

8. An information processing method, comprising
switching, by a controller, a weight coefficient set of a neural network with a learned weight coefficient set selected from a plurality of learned weight coefficient sets, recognition processing being performed for the weight coefficient set of the neural network.

9. The information processing method according to claim 8, further comprising
storing the plurality of learned weight coefficient sets in a storage unit.

10. The information processing method according to claim 9, wherein
each of the plurality of learned weight coefficient sets is prepared for each target condition for the recognition processing of the recognition unit.

11. The information processing method according to claim 10, wherein
the controller merges a plurality of learned weight coefficient sets, which is included in the plurality of learned weight coefficient sets stored in the storage unit, into a learned weight coefficient set, and sets the learned weight coefficient set in the neural network.

12. The information processing method according to claim 11, wherein
the controller obtains a mean of weight coefficients between identical units in each of the plurality of learned weight coefficient sets, to thereby merge the plurality of learned weight coefficient sets into a learned weight coefficient set.

13. The information processing method according to claim 11, wherein
the controller obtains a mean and a maximum value of weight coefficients between identical units in each of the plurality of learned weight coefficient sets and multiplies the mean value with the maximum value, to thereby merge the plurality of learned weight coefficient sets into a learned weight coefficient set.

14. The information processing method according to claim 11, wherein
the controller selects one or more learned weight coefficient sets from the plurality of learned weight coefficient sets on a basis of a selection command from a user.

15. A program that causes a computer to function as:
a recognition unit that performs recognition processing by using a neural network; and
a controller that switches a weight coefficient set of the neural network with a learned weight coefficient set selected from a plurality of learned weight coefficient sets.
